(19) United States
(12) Patent Application Publication
(10) Pub. No.: US 2001/0017720 A1
(43) Pub. Date: Aug. 30, 2001

(54) Combination photonic time and wavelength division demultiplexing method

(76) Inventor: John N. Hait, San Diego, CA (US)

Correspondence Address: PATE PIERCE & BAIRD, BANK ONE TOWER, SUITE 900, 50 WEST BROADWAY, SALT LAKE CITY, UT, 84101, US

(21) Appl. No.: 09/810,885

(22) Filed: Mar. 16, 2001

Related U.S. Application Data
(63) Continuation-in-part of application No. 09/075,046, filed on May 8, 1998, now Pat. No. 6,256,124.

(51) Int. Cl. H04J 4/00; H04J 14/00; H04J 14/08

(52) U.S. Cl. 359/123; 359/135

(57) ABSTRACT

A method and apparatus are hereby disclosed for a combination photonic time and wavelength-division demultiplexer. A serial photonic signal comprising sets of synchronizing pulses and “n” sets of data pulses is received at the input of the demultiplexer. A pulse separator separates the synchronization pulses from the serial photonic signal to be transmitted to “n” photonic gates. A series of “n” delay mechanisms in a parallel configuration also receive the serial photonic signal and delay the signals such that the “n” sets of data pulses coincide with the timing of the synchronization pulses. The “n” photonic gates receive the “n” sets of data signals and the synchronization pulses simultaneously, thereby passing only the “n” sets of data signals and providing parallel photonic data or the parallel electronic data may be remultiplexed. The parallel data may be subsequently received by “n” pulse stretchers configured to stretch the pulses sufficiently to fall within the response time of “n” optoelectronic devices in a parallel configuration. In this manner, a photonic serial input may be converted to a parallel digital electronic output. Thus, the present invention discloses a serial photonic to parallel electronic demultiplexer wherein slower electronic devices may be interfaced with faster photonic components.

### RELATED APPLICATIONS

This application is a continuation-in-part of a co-pending patent application, Ser. No. 09/075,046, filed on May 8, 1998 and directed to a Combination Photonic Time and Wavelength Division Multiplexer.

### BACKGROUND

1. The Field of the Invention

This invention relates to frequency and time division demultiplexing of photonic signals, serial-to-parallel conversion of photonic signals, preparing high-speed photonic signals for processing by lower-speed electronics, and the reception of data digits having more than two stable modulation states and which use a variety of modulation methods.

2. The Background Art

Elementary photonic time division demultiplexers are taught in U.S. Pat. No. 6,623,366 to Hait. What Hait does not teach is the apparatus and method of implementing a photonic time-division demultiplexer that uses incoming synchronization pulses to time serial-to-parallel conversion.

Hait also does not teach the use of delay mechanisms, including waveguides and optical fibers, to perform timing functions throughout the photonic demultiplexing circuits based on the incoming synchronization signals.

Nor does Hait teach the delaying of input data by one data digit time in parallel lines to facilitate the simultaneous reading of input data to output parallel data simultaneously. Nor does Hait teach a combination of frequency (wavelength) and time-division dermultiplexing.

Hait further does not teach pulse stretching and the use of stretched pulses to interface hlgh-speed photonics with lower-speed electronics. Nor does it teach the use of stretched synchronization pulses for separating synchronization pulses and sets of data pulses.

Also not taught in Hait is the use of data comprising more than two modulation states and the use of data comprising combinations of modulation types. Thus, it fails to teach how multi-state, multi-modulation-type transmissions may increase the effective bandwidth of digital transmissions.

What is needed is apparatus and methods that provide the foregoing features.

### BRIEF SUMMARY AND OBJECTS OF THE INVENTION

The present invention is a apparatus and method of frequency (wavelength) and time-division demuitiplexing in which serial photonic information is converted to parallel photonic or parallel electronic information. In certain embodiments, the incoming serial signal to the demultiplexer may comprise photonic pulses that start with a synchronization pulse followed by a set of “n” data pulses, the integer “n” being the number of data pulses that make up a data set. The synchronization pulses may be used to signal when the data pulses begin and end.

Synchronization pulses may be separated from the data pulses and delayed using a synchronization delay mechanism. If different carrier frequencies are used, synchronization pulses may be separated for each frequency channel.

The serial input is also distributed to “n” delay mechanisms to produce “n” copies of the input data set, each successive copy being delayed by a different amount of time. Each of these delay mechanisms may differ in delay time by the duration of one data pulse so that each data pulse in a data set is timed to match the delayed synchronization pulse.

The “n” delayed data pulse sets may be input into “n” photonic gates. Thus, all “n” photonic gates may be opened simultaneously by the delayed synchronization pulse(s). Since each gate has, at the time of the delayed synchronization pulse(s), a different data pulse at its input, opening these gates simultaneously during that delayed synchronization pulse may output simultaneous parallel individual data pulses that may be transmitted to other photonic devices.

One advantage of outputting parallel data rather than sequential data is that external parallel circuitry may be more easily interfaced with the present invention. By delaying the data pulses in parallel lines and reading them simultaneously after the last data pulse has arrived, the entire parallel data set may be output simultaneously. Accordingly, such output may be connected to other photonic or electronic circuitry.

Photonic pulses may be much shorter than the response time of the typical electro-optical device. To interface slower electronics with high-speed data pulses, photonic pulse stretchers may be provided to increase the pulse width of the parallel photonic outputs enough to make the data signals compatible with the electronic devices to be used with the present invention.

Thus, one advantage of the present invention is that slower electronics may now be interfaced with higher-speed photonics. By providing simultaneous parallel data, the same time span needed for serial data transmission of a full data frame (which includes one synchronization pulse and one full data set) may be made available for stretching photonic signals during the transmission of the following frame. As a result, the stretched pulses may be read by slower electro-optical devices without interrupting the sequence of frames.

To allow for this needed interface time, the number of data digits in a single data set may be increased until the full data set transmission time is at least as long as the needed electronic response time. As a result, both the photonics and the electronics may be made to operate at peak technological performance.

Because photonics and fiber optic systems are able to operate so much faster than electronics, a typical system may have many hundreds or even thousands of data pulses per frame to provide enough time for electronic circuits to respond. As a result, one particular embodiment of the present invention may provide a thousand or more parallel output lines. Such large electronic bus widths may be used with present electronics, even if a large number of electronic computers are required to fully use the capability. Incoming data may be organized during transmission so that each receiving computer gets its proper information.

The present invention may also be able to accept data frames asynchronously on separate carrier frequencies.

Another advantage of the present invention is that it may be able to use the large variety of photonic gates available in the art and may not be restricted to a specific photonic gate except by engineering choice. Such photonic gates include the use of negative logic and multilevel negative synchronization and data pulses wherein the logic output is substantially off while the data positions are being read by the delayed synchronization pulse.

At least two of the “n” data slots are required to define the present invention.

Therefore, the basic method of the present photonic serial-to-parallel converter using delayed-pulse timing may include the elements and methods of the following paragraphs. in certain embodiments, an apparatus in accordance with tile invention may receive a serial input signal comprising pulses of photonic energy having synchronization pulses and sets of data pulses, the data pulses including at least first and second sets of data pulses. A synchronization pulse separator may be configured to receive the serial input signal and separate the synchronization pulses from the serial input signal to provide separated synchronization pulses. First and second photonic gates may be configured to receive the separated synchronization pulses, thereby opening the gates.

Meanwhile, the serial input containing the first and second sets of data pulses may be received in parallel by first and second delay mechanisms. These may be configured to delay the serial input by first and second delays and and transmit them to the first and second photonic gates, respectively. The first and second delays are timed such that the first and second sets of data pulses arrive simultaneously at the first and second photonic gates coincidentally with the synchronization pulses, thereby providing first and second parallel outputs from the first and second photonic gates. Thus, the first and second sets of data pulses contained in the serial input signal may be converted to parallel data.

Since electronic components are typically much slower than photonic components, to interface the photonic data outputs with electronic components, first and second pulse stretchers may be provided to stretch the first and second parallel outputs sufficiently so as to fall within the response time of first and second optoelectronic devices. Accordingly, the first and second optoelectronic devices provide first and second parallel electronic outputs.

To interface photonic synchronization with electronic components, a third pulse stretcher may be used to stretch the synchronization pulses sufficiently to fall within the response time of a third optoelectronic device, used to provide an electronic synchronization pulse. Such an electronic synchronization pulse may be used by the present invention to provide an indicator when the parallel electronic outputs are setup and ready to be read.

Separating synchronization pulses from the input pulse stream may be necessary to prevent data information from adversely affecting the demultiplexing process with certain synchronization pulse transmission methods. Photonic separation may be quite advantageous because available photonic switching components are much faster than their electronic equivalents.

The present invention may use pulse timing and delay mechanisms to provide synchronization pulses that have been separated from the input data stream. In one embodiment, the serial input may be directed into a photonic inhibiting gate that passes information through until an inhibiting signal prevents passage.

Because each synchronization pulse, which is comparable to the start pulse used in asynchronous electronic communications, arrives before the data, that synchronization pulse may be reproduced and delayed to coincide with each of the following data pulses. The synchronization pulse may also be stretched into an inhibiting pulse to cover the time used by each data set and used to inhibit passage of data through the inhibiting gate.

Since the stretched inhibiting pulse may be timed to shut off after the nth data pulse, the inhibiting gate may be reopened in preparation for the following synchronization pulse of the following asynchronous frame. The result is photonicly separated synchronization pulses.

In one embodiment, the method for separating the synchronization pulses from the data may include an inhibiting gate and a synchronization pulse stretcher, wherein the serial input is received by the inhibiting gate. A pulse stretcher may be connected to the inhibiting gate and configured to stretch the synchronization pulses to provide inhibiting pulses substantially as long as the sets of data pulses contained within the serial input. These inhibiting pulses are also timed to coincide with the sets of data pulses. The inhibiting pulses may be routed back into the inhibiting gate to close the inhibiting gate, thereby allowing only the synchronization pulses to pass through the inhibiting gate and preventing the sets of data pulses to pass therefrom. Thus, in this embodiment a method is provided to separate the synchronization pulses from the serial input.

In certain embodiments, a method for stretching photonic pulses may include receiving a photonic pulse having a length. The photonic pulse may be directed in parallel to a plurality of delay mechanisms, each having a delay differing substantially by the length of the photonic pulse. The number of delay mechanisms used within the pulse stretcher may be determined by the pulse length needed. Subsequently, the outputs from each of the delay mechanisms may be combined into a single stretched pulse having a length greater than the original pulse length.

The effective bandwidth of a binary transmission system may be increased by using analog or multi-state digital transmissions such as ternary, quadnary, hexadecimal, and so on. The present invention has the advantage of being able to time-division demultiplex multi-state signals by providing multi-state serial inputs and selecting components compatible with multi-state signals. Such input could be made either photonic or electronic by choosing the appropriate components.

One object of the present invention is to provide a versatile time-division demultiplexer that is capable of using photonics at the highest speed that is technologically feasible.

Another object of the present invention is to provide a photonic to electronic time-division demultiplexer that may provide parallel electronic output at the highest speed that is technologically feasible for electronic components.

Another object of the present invention is to provide a demultiplexer that may be tailored to match a wide variety of photonic transmission apparatus and methods and a wide variety of photonic and electronic output interfacing.

Another advantage of the present invention is that it will work with a wide variety of photonic modulation methods, including amplitude, phase, polarization, and spatial modulation for the data pulses as well as the synchronization pulses. Just as compatible synchronization separation, delay mechanisms and gates may be selected for use with amplitude modulation, components may be selected to facilitate operation based on changes in carrier phase, polarization, or spatial positioning of photonic energy.

Spatial modulation has the ability to carry a considerable amount of information in parallel, including whole images. Delay mechanisms used with spatial modulation need only be able to maintain spatial relationships, and gates need only be able to turn the entire spatially modulated signal on during the data pulse read time to yield time-division multiplexed information in a corresponding multiplexer capable of producing a series of light-speed images. This occurs much as a moving picture sends a series of light-speed images toward a movie screen or is demultiplexed using the present invention for routing individual images or groups thereof.

Another advantage of the present invention is that it may provide multi-state outputs from multi-state inputs, thereby increasing the effective bandwidth of the present invention by increasing the amount of information that is contained within a single data pulse time. Modulation-type, level-sensing, and switching components such as those of U.S. Pat. Nos. 5,093,802, 5,623,366 and 5,466,925 may be used with the present invention to convert multi-state reception from nonbinary to binary information and may be inserted between the “n” parallel photonic outputs and the pulse stretchers. Alternatively, the conversion from nonbinary to binary may be done electronically.

Combinations of the above modulation methods may be easily used together to provide multi-state operation compatible with a variety of external photonic and/or electronic circuitry.

Another advantage of the present invention is that it may be constructed using components compatible with frequency (wavelength) division multiplexing such as the frequency-multiplexed logic of U.S. Pat. No. 5,617,249. As aresult, the present invention may be used with a variety of multi-state, multi-modulation-type, multi-frequency time-division multiplexed signals.

The foregoing objects and benefits of the present invention will become clearer through an examination of the drawings, description of the drawings, description of the preferred embodiment, and claims that follow.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a block diagram of a photonic serial to parallel converter that constitutes the time-division demultiplexer of the present invention;

FIG. 2 is a pulse timing diagram of the demultiplexer in accordance with the invention;

FIG. 3 is a pulse diagram illustrating several examples of multistate inputs/outputs; and

FIG. 4 is a block diagram of one embodiment of a pulse stretcher that uses multiple delay mechanisms in a parallel configuration.

### DETAILED DESCRIPTION OF THE PREFERRED EMBODIMENTS

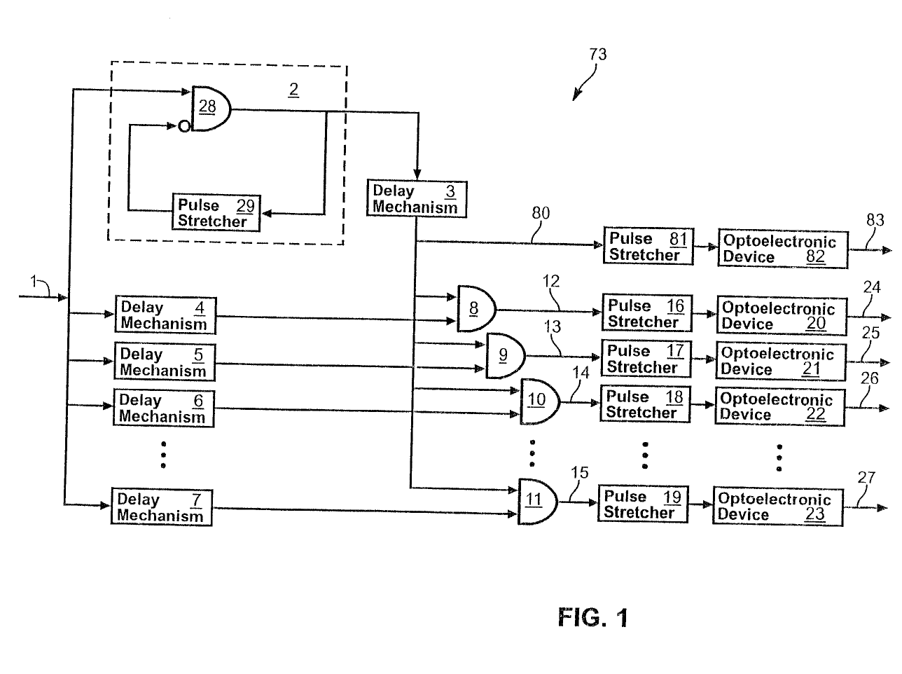

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 5, is not intended to limit the scope of the invention. The scope of the invention is as broad as claimed herein. The illustrations are merely representative of certain, presently preferred embodiments of the invention. Those presently preferred embodiments of the invention will be best understood by reference to the drawings, wherein like parts are designated by like numerals throughout.

Those of ordinary skill in the art will, of course, appreciate that various modifications to the details of the Figures may easily be made without departing from the essential characteristics of the invention. Thus, the following description of the Figures is intended only by way of example, and simply illustrates certain presently preferred embodiments consistent with the invention as claimed.

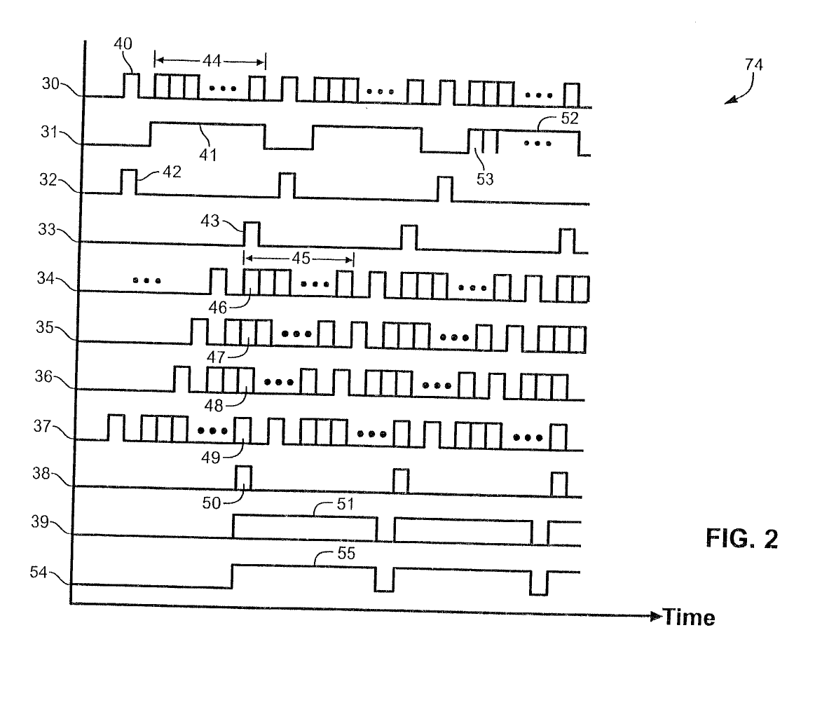

Because FIG. 1 is a block diagram of the time/frequency division demultiplexer, serial-to-parallel converter of the present invention and FIG. 2 is a pulse timing diagram of the various signals within the apparatus of FIG. 1, this embodiment is best understood by considering both figures together. Reference characters used in the following description that are less than 30 and greater than 79 refer to FIG. 1. Likewise, reference characters between 30 and 55 refer to FIG. 2.

Referring to FIG. 1 and FIG. 2, a serial photonic signal comprising a series of pulses as illustrated on time line 30 may be received by the invention at input 1. The serial photonic signal may comprise a frame of pulses that include a synchronization pulse such as pulse 40 and a set of “n” data pulses such as data frame 44 followed by like frames of synchronization and data pulses.

The integer “n”, as used hereinafter, refers to the number of data pulses in the data set of a single frame, which is positioned in time between the synchronization pulses. The first three data pulses plus the n^{th} data pulse are illustrated in FIG. 2, such as is illustrated in data frame 44. The three dots between pulses shown on time lines 30, 31 and 34-37 of FIG. 2 indicate similar data pulses, and the three dots between components in FIG. 1 indicate similar components used to process each of the interceding data pulses. At least first and second data pulses are required to have serial data converted into parallel data.

Referring to FIG. 2, pulses represented by a top line only, such as 40 and 42, are required pulses. Pulses having both a top and bottom line, such as data frame 44 and data signal 50, are modulated with data and may be able to be in a number of modulation states depending on the data transmission method. In the case of multi-level modulation states, these pulses represent time positions and relationships for accomplishing specific tasks rather than binary conditions.

The present invention may use a number of delay mechanisms for coordinating the timing of the various signals. Photonic delay mechanisms may be free-space distances through which signals are made to travel, fiber optics, waveguides, or complex circuits that may include amplifiers, flip flops, one-shot multivibrators, and the like to produce the delays.

To accomplish serial-to-parallel conversion, the synchronization pulses may be first separated from input 1 using a synchronization pulse separator 2 that produces, for example, a sequence of synchronization pulses like synchronization pulse 42 as shown on time line 32. If the synchronization pulses are modulated or positioned in an otherwise recoverable form, they need not precede the data pulse time slots, as shown on time line 30. The exact requirements for synchronization pulse separation may depend upon the modulation and timing characteristics of the synchronization pulses provided at input 1. Certain modulation configurations may require no modification of the input signal before it is routed to photonic gates 8-11. In this case, synchronization pulse separator 2 may merely consist of the separation of an amplitude portion of the input signal from input 1. As a result, the present invention may provide considerable latitude for engineering choice and for customizing the present invention to match a large variety of transmission protocols.

Separated synchronization pulses shown on time line 32 may then be delayed using delay mechanism 3 to produce the delayed synchronization pulses shown on time line 33. For example, delayed synchronization pulse 43 shows the delay that has occurred when compared to synchronization pulse 42. These delayed synchronization pulses may be used to read each of the “n” data time slots within a set of “n” data pulses such as data frame 44 shown on time line 30 to produce a parallel photonic data output as shown on time line 38. Since all of the “n” data pulses in the parallel photonic data output may be made to occur at the same time, the pulse waveforms for each output will appear the same as those shown on time line 38.

The pulses such as synchronization pulse 40 and those in data frame 44 of input 1 as shown on time line 30 may also be routed into “n” delay mechanisms 4-7, the nth delay mechanism. Time lines 34 through the n^{th} time line, 37, show what happens to pulses that are routed through “n” delay mechanisms 4-7, the n^{th} delay mechanism. Each of these “n” delay mechanisms may have a time delay that differs by the time of a single data pulse such as data pulse 46. As a result, delayed data signals as shown by time lines 34 through the nth time line, 37, may be produced such that each delayed data signal has a different data pulse timed to match a delayed synchronization pulse. For example, the data pulse 46 in delayed data pulse set 45 is timed to match delayed synchronization pulse 43.

Likewise, the second delayed data signal as shown on time line 35 has its second data pulse 47 timed to match delayed synchronization pulse 43, the third delayed data signal shown on time line 36 has its data pulse 48 timed to match delayed synchronization pulse 43, and the n^{th} delayed data signal shown on time line 37 has its nth data pulse 49 timed to match delayed synchronization pulse 43. All “n” delayed data signals are routed into photonic gates 8-11, the n^{th} photonic gate. These photonic gates remain closed until they are opened by the delayed synchronization pulses shown on time line 33. In the example illustrated by the time lines of FIG. 2, delayed synchronization pulse 43 opens gates 8-11 to allow data pulses 46-49 to pass into parallel photonic outputs 12-15, the n^{th} photonic output, all of which are shown as data signal 50 as explained previously. When the photonic gates are closed, the other pulses within each of the “n” delayed data signals are blocked because the delayed synchronization pulse signal is off.

These parallel photonic data outputs as shown on time line 38 may be routed directly into other photonic devices as needed. Photonic pulses, however, may be much shorter than the response time of electronic or other devices. To interface the photonic output to an electronic circuit, pulse stretchers 16-19, the n^{th} pulse stretcher, one construction of which is shown in FIG. 4, may be connected to photonic outputs 12-15.

The outputs of these pulse stretchers as shown on time line 39, such as stretched pulse 51, may then be received by optoelectronic devices 20-23, the n^{th} optoelectronic device, such as photo diodes. In turn, these optoelectronic devices 20-23 may provide parallel electronic outputs 24-27, the nth electronic output. Electronic outputs may occur during the same pulse times shown on time line 39, but slower electronic responses may cause the waveforms to deviate from the square-wave form as illustrated. This may be used to the advantage by directing the short pulses from the signals 12-15 into optoelectronic devices directly, then correcting the distorted outputs electronically using electronic wave-shapers, for example. This may be accomplished while performing the pulse stretching electronically because the present invention produces long time delays between the demultiplexed pulses that leave time for pulse stretching.

A variety of photonic gates 8-11, the n^{th} photonic gate, may be used including photonic transistors, frequency multiplexed logic, nonlinear optical elements, Self Exciting Electro-optical Devices (SEEDS), and other high-speed optical gates. While FIG. 1 uses the conventional pictorial notation that indicates the use of a Boolean AND, any of the switching equivalents will work, including the use of negative logic wherein the positive Boolean OR provides the AND gate function.

The present invention can be used with both time-division multiplexed and wave-division multiplexed signals. In fact, using suitable components, the present invention can also be used with legacy systems of time-division multiplexing and wave-division multiplexing. In one embodiment, the photonic gates 8-11 of FIG. 1, can be photonic transistors of frequency-multiplexed logic components. Such components have been shown to have extremely fine photonic resolution which, when incorporated into the present invention, allow the invention to have a much finer resolution for determining one frequency channel or wave-division multiplexed channel from its neighbor. Being a much finer filter that is often used in cases of prisms, diffraction gratings, and the like, the present invention can demultiplex far more information from the serial data input than conventional methods.

A synchronization strobe is usually needed so that outside devices will know when parallel data is set up and ready to be read. For example, delayed synchronization pulses, such as synchronization pulse 43 as shown on time line 33, may be routed alone line 80 of FIG. 1 to provide a photonic synchronization output to indicate when photonic outputs 12-15 are set up and ready to be read.

If an electronic or other slow interface is needed, the delayed synchronization pulses on line 80 may be directed to a pulse stretcher 81, one construction of which is shown in FIG. 4, to provide stretched synchronization pulse 55 as shown on time line 54. These stretched synchronization pulses 55 are then routed into optoelectronic device 82 to provide an electronic strobe 55 or electronic synchronization 55 at output 83, also shown on time line 54.

Depending on the components and interfacing configuration chosen, an additional delay may need to be included en route so that parallel data output has time for complete setup before the strobe indicates that it is ready. This delay may be built in to the invention at any point from line 80 through output 83, or external circuitry may be used to provide the needed strobe timing. The separated synchronization signal received from synchronization pulse separator 2 may also be used, rather than using the output of delay mechanism 3, by including extra delay mechanisms as engineering requires.

One important advantage of the present invention is that the number of data pulses in a data set, such as data frame 44, may be engineered to allow enough time to meet the response characteristics of the electronic components interfaced to the present invention. The available time for electronic response may be lengthened by including more data pulses in a data frame.

For example, common optoelectronic devices are capable of operating at a speed of 2 Ghz with a pulse time of 0.5 ns (nanoseconds), whereas photonic pulses may be produced having a much shorter pulse duration of, for example, 0.0005 ns. As a result, if n=1,000, then each of 1,000 parallel outputs may operate at the maximum speed for these available electronic components, while using the speed advantage of photonics to increase the overall bandwidth.

A variety of mechanisms may be used within the synchronization pulse separator 2 for separating the synchronization pulses, such as synchronization pulse 40, shown on time line 30 from input 1. One embodiment may include the use of a pulse stretcher 29 that produces an output started by each synchronization pulse, such as synchronization pulse 40, to produce inhibiting pulses such as inhibiting pulse 41, as shown on time line 31, which are at least as long as data frame 44, shown on time line 30.

Some transmission systems may provide shorter synchronization pulses so that the data read will take place completely within the delayed data pulses. In that case, the number of delay mechanisms 68-71 used in the synchronization pulse stretcher 76 may have to be increased. For transmission systems that do not use shorter synchronization pulses, a synchronization pulse shortener may be needed prior to photonic gates 8-11. Photonic pulses may be shortened using devices as described by Hait in U.S. Pat. No. 5,623,366.

Following synchronization pulse 40, inhibiting pulse 41 may close inhibiting gate 28, which prevents the following data frame 44 from passing through inhibiting gate 28. Inhibiting pulse 41 may be engineered to shut off following the last data pulse in data frame 44 to open inhibiting gate 28 in time to allow the next synchronization pulse to pass. As a result, only synchronization pulses, such as synchronization pulse 42, shown on time line 32, pass through gate 28 and, therefore, out of separator 2.

Synchronization pulse separation may also be accomplished using synchronization pulses that have modulation characteristics different from those of the data pulses. Some of these may include different amplitude, phase, polarization, frequency, and wave form. The synchronization pulse may also be derived from data transmission protocols, as is common in electronics, by using photonic components that are compatible with the high-speed switching characteristics of photonic transistors, etc.

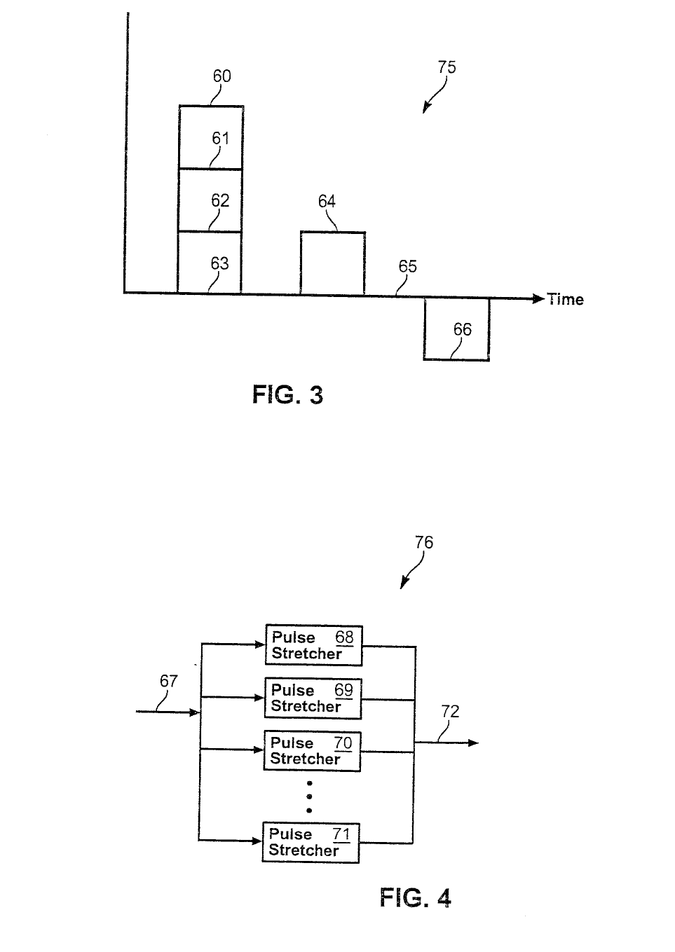

Referring to FIG. 3, multi-state data pulses may also be used to increase effective bandwidth of the multiplexing system. FIG. 3 illustrates two examples of the many possible combinations of multi-state semaphore digits (for synchronization or data) that may be demultiplexed from multi-state serial inputs to multi-state parallel outputs.

For example, quadnary transmission may use four pulse levels. Rather than being simply on or off as in the case of binary transmission, one of the transmission levels 60, 61, 62, or 63 may be transmitted at a time to represent two bits of binary information. The present invention may pass these levels 60-63 through into its photonic outputs 12-15 and pulse stretchers 16-19 to its electronic outputs 24-27.

Another example of multi-state transmission is illustrated by transmission levels 64-66. In this case, both amplitude and phase modulation may be combined to produce a ternary system. Level 64 may have a carrier wave phase that is 180 degrees out of phase with level 66. Level 65 may be amplitude-modulated so that it is substantially off. This type of transmission may be particularly compatible with interference-based photonics since it is the type of signal naturally produced by certain photonic transistors of the prior art.

The present invention may be compatible with a variety of modulation methods, including amplitude, phase, spatial, and polarization modulation by the proper engineering choice of compatible photonic components. As shown in FIG. 3, these various modulation methods, including Walsh functions, may be mixed and matched to produce complex informational systems that may be converted from higher-speed serial to lower-speed parallel signals by the present invention.

Amplifiers, both photonic and electronic, may be inserted as needed in the various signal lines of the present invention. Pulse stretchers using photonic components such as flip flops and one-shot multivibrators of the prior art as in U.S. Pat. Nos. 5,093,802 and 5,623,366 may also be used.

Referring to FIG. 4, a simple photonic pulse stretcher 76 of a type that may be used as any of the pulse stretchers 16-19, pulse stretcher 29, or pulse stretcher 81, is illustrated in FIG. 4. Delay mechanisms 68-71, the n^{th} delay mechanism, may transmit pulses such as pulse 42, shown on time line 32, to pulse stretcher input 67. Each of the successive delay mechanisms 68-71 may have a delay that is approximately the width of one data pulse (such as pulse 50 on time line 38) longer than the preceding one. When the delayed outputs at pulse stretcher output 72 are combined, a single stretched pulse such as data 51, shown on time line 39, may be produced.

The present invention may also be compatible with certain time-division multiplexing transmitters that use synchronization pulses having a pulse width different from that of the data pulses. In this case, the number of delay mechanisms in FIG. 4 may simply be adjusted to provide the needed stretched pulse width. Additionally, amplifiers may be inserted either inside or outside of the delay mechanism as needed to provide proper signal strengths.

The present invention may use negative logic by providing separated synchronization pulses that are off at the data testing coincidence time (as previously illustrated by delayed synchronization pulse 43 and data signal 50) by inverting the signal on time line 33. An advantage of negative logic may be that the negative synchronization pulse does not always have to be phase-matched to the incoming signal at input 1 before coincidence at photonic gates 8-11. Negative logic as used in the present invention may be used with noisy and otherwise difficult-to-detect input signals. A negative logic synchronization pulse may be produced by inverting the separated synchronization pulses 43, or by using a negative input synchronization pulse with or without the positive synchronization pulse 40. The use of multi-level input signals may also simplify engineering choices.

The present invention may also be used as a combination wavelength and time-division multiplexer by using frequency-multiplexed logic such as taught in U.S. Patent No. 5,617,249 at photonic gates 8-11. Wavelength-division multiplexed signals for each time division may be maintained at photonic outputs 12-15. Alternatively, the synchronization pulses may be separated by wavelength in the synchronization pulse separator 2 and routed to separate photonic gates, thereby permitting the entire spectrum of wavelength and time-division multiplexed signals to be completely demultiplexed into separate parallel outputs.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. A method for converting serial photonic signals to parallel signals, the method comprising:
receiving a serial photonic signal having a first wavelength, the serial photonic signal comprising a series of synchronization pulses and first and second sets of photonic data pulses;
separating the series of synchronization pulses from the serial photonic signal;
transmitting the series of synchronization pulses to first and second photonic gates so that the gates are opened by the synchronization pulses;
transmitting the serial photonic signal to the first photonic gate, using a first delay period, so that the first set of photonic data pulses arrives coincidentally with the synchronization pulses, thereby passing only the first set of photonic data pulses through the first photonic gate; and
transmitting the serial photonic signal to the second photonic gate, using a second delay period, so that the second set of photonic data pulses arrives
coincidentally with the synchronization pulses, thereby passing only the second set of photonic data pulses through the second photonic gate.

2. The method of claim 1, further comprising stretching the pulses of the first and second sets of photonic data pulses;

3. The method of claim 2, further comprising providing first and second optoelectronic devices, having response times, configured to convert the stretched first and second sets of photonic data pulses to first and second parallel outputs;

4. The method of claim 3, wherein the first and second sets of photonic data pulses are stretched at least as long as the response times of the first and second optoelectronic devices.

5. The method of claim 4, wherein the synchronization pulses further provide an indicating signal when the first and second optoelectronic devices are ready to output the first and second parallel outputs.

6. The method of claim 5, wherein separating the series of synchronization pulses from the serial photonic signal further comprises providing a pulse stretcher and an inhibiting gate configured to impede the first and second sets of photonic data pulses from passing through the inhibiting gate.

7. The method of claim 6, wherein the first and second sets of photonic data pulses comprise multi-level non-binary signals.

8. The method of claim 7, wherein the first and second parallel outputs comprise multi-level non-binary signals.

9. The method of claim 1, further comprising providing first and second optoelectronic devices, having response times, configured to convert the first and second sets of photonic data pulses to first and second parallel outputs;

10. The method of claim 1, further comprising providing first and second optoelectronic devices, having response times, and stretching the pulses of the first and second sets of photonic data pulses, wherein the first and second sets of photonic data pulses are stretched at least as long as the response times of the first and second optoelectronic devices.

11. The method of claim 1, further comprising providing first and second optoelectronic devices configured to produce first and second parallel outputs, wherein the synchronization pulses are further used to indicate when the first and second optoelectronic devices are ready to output the first and second parallel outputs.

12. The method of claim 1, wherein separating the series of synchronization pulses from the serial photonic signal further comprises providing a pulse stretcher and an inhibiting gate configured to impede the first and second sets of photonic data pulses from passing through the inhibiting gate.

13. The method of claim 1, wherein the first and second sets of photonic data pulses comprise multi-level non-binary signals.

14. The method of claim 1, further comprising providing first and second optoelectronic devices configured to produce first and second parallel outputs, wherein the first and second parallel outputs comprise multi-level non-binary signals.

15. The method of claim 1, wherein the first and second sets of photonic data pulses are selected from the group consisting of amplitude-modulated, phase-modulated, polarization-modulated, spatially modulated, and frequency-modulated pulses.

16. The method of claim 1, wherein the first and second sets of photonic data pulses include multi-level semaphores.

17. The method of claim 1, further comprising selecting a third set of photonic data pulses having a second wavelength.

18. The method of claim 17, wherein the synchronization pulses include pulses of the first and second wavelengths.

19. The method of claim 18, further comprising:
transmitting the series of synchronization pulses to a third photonic gate so that the gate is opened by the synchronization pulses; and
transmitting the serial photonic signal to the third photonic gate, using a third delay period, so that the third set of photonic data pulses arrives coincidentally with the synchronization pulses, thereby passing only the third set of photonic data pulses through the third photonic gate.

20. The method of claim 2, wherein the first and second photonic gates are selected from the group consisting of photonic transistors, frequency multiplexed logic, nonlinear optical elements, and self electro-optical devices.
